(19) United States
(12) Patent Application Publication
(10) Pub. No.: US 2009/0189919 A1
(43) Pub. Date: Jul. 30, 2009

(54) IMAGE SCALING METHOD

(76) Inventor: Chou-Liang Tsai, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/020,823

(22) Filed: Jan. 28, 2008

(51) Int. Cl. G09G 5/00

(52) U.S. Cl. 345/660

(57) ABSTRACT

An image scaling method is disclosed. In the image scaling method, at first dividing an original image into a plurality of original image columns, wherein each of the original image columns comprises original pixel rows. Thereafter respectively performing a scaling step on the original image columns, thereby generating scaled image columns. Then combining each of the scaled image columns. In the scaling step, writing some of the original pixel rows into a buffer, wherein the buffer is first in first out (FIFO) buffer. Thereafter performing an interpolation on the data stored in the buffer to generate first scaled pixel rows. Then sequentially writing the other original pixel rows into the buffer, and performing the interpolation on the data stored in the buffer after each one of the other original pixel rows is written into the buffer, thereby generating second pixel rows. Thereafter combining the first and second pixel rows.

### FIELD OF THE INVENTION

This invention relates to an image scaling method, and more particularly, to techniques for using interpolation to scale an image.

### BACKGROUND OF THE INVENTION

Recently, because the image processing technology is improved, the image processing technology plays an important role in human's life. In the mage processing technology, the image scaling technology is the most popular technology. Image scaling technology is used for transferring a source image to a scaled image, thus that it is an important technology in medical image processing, digital picture processing and etc.

Referring to FIG. 1. FIG. 1 is a structure diagram showing a source image 10, wherein the source image 10 comprises a plurality of pixels 11. In a conventional image scaling method, at first a first pixel row 12 is written into a line buffer. Then the pixels of a second pixel row 14 are read one by one, and after one pixel of the second pixel row 14 is read, an interpolation step is performed on the pixel and the first pixel row 12. Thereafter, the second pixel row 14 is written into the line buffer. Then the pixels of a third pixel row 16 are read one by one and performing the interpolation step after one pixel of the third pixel row 16 is read. Sequentially performing the interpolation step on the pixels of the source image to obtain the scaled image.

In the conventional image scaling method, a line buffer having sufficient memory size for storing the data of one pixel row is required. However, some of mobile display devices may not provide enough memory size for the conventional image scaling method. Therefore, a new image scaling method is required.

### SUMMARY OF THE INVENTION

Therefore, an aspect of the present invention is to provide an image scaling method, and in the image scaling method, a line buffer having sufficient memory size for storing the data of one pixel row is not required

According to an embodiment of the present invention, the image scaling method comprises: providing an original image; dividing said original image into a plurality of original image columns, wherein each of said original image columns comprises a plurality of first original pixel rows; respectively performing a scaling step on said original image columns, thereby generating a plurality of scaled image columns, wherein said scaled image columns are one-to-one corresponding to said original image columns; and combining each of said scaled image columns to generate said scaled image.

According to the embodiment of the present invention, the scaling step comprises: selecting a plurality of second pixel rows from said first pixel rows with respect to said original image column, wherein said second original pixel rows are consecutive to each other; writing said second original pixel rows into a first in first out (FIFO) buffer; performing an interpolation algorithm on the pixel row data stored in said FIFO buffer, thereby scaling the pixel row data to generate at least one first scaled pixel rows; sequentially writing the other original pixel rows of said first pixel rows into said FIFO buffer one by one, and performing the interpolation algorithm on the pixel row data stored in said FIFO buffer after each one of the other first original pixel rows is written into said FIFO buffer, thereby scaling the pixel row data stored in said line buffers to generate at least one second scaled pixel rows; and combining said first scaled pixel rows and said second scaled pixel rows to generate said scaled image column.

According to the embodiment of the present invention, said FIFO buffer comprise a plurality of memories, and said second original pixel rows are written into said memories respectively in a one to one manner.

According to the embodiment of the present invention, the capacitance of each of said memories is equal to the bits of each of said first original pixel row.

According to another embodiment of the present invention, said interpolation algorithm is selected from the group consisting of neighbor interpolation algorithm, linear interpolation algorithm, bilinear interpolation algorithm, cubic spline interpolation algorithm, and cubic convolution interpolation algorithm.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a structure diagram showing a source image;

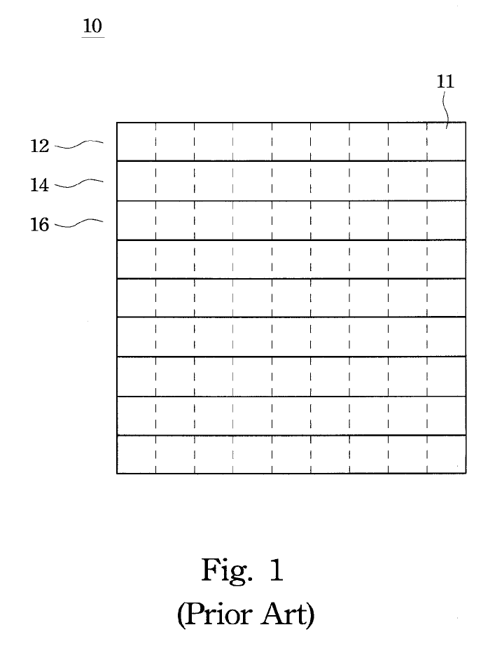

FIG. 2 is a flow chart showing an image scaling method according to an embodiment of the present invention;

FIG. 3 is a structure diagram showing an original image according to the embodiment of the present invention;

FIG. 4 is a structure diagram showing a scaled image 300 according to the embodiment of the present invention; and

FIG. 5 is a flow chart showing the scaling step according to the embodiment of the present invention.

### DETAILED DESCRIPTION OF THE PREFERRED EMBODIMENT

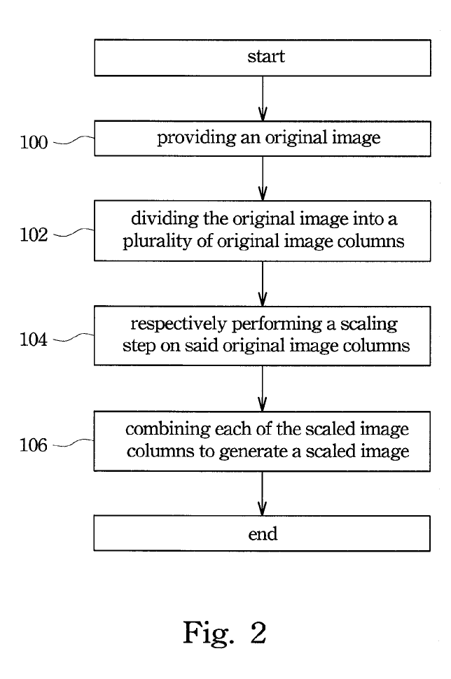

In order to make the illustration of the present invention more explicit and complete, the following description is stated with reference to FIG. 2 through FIG. 5

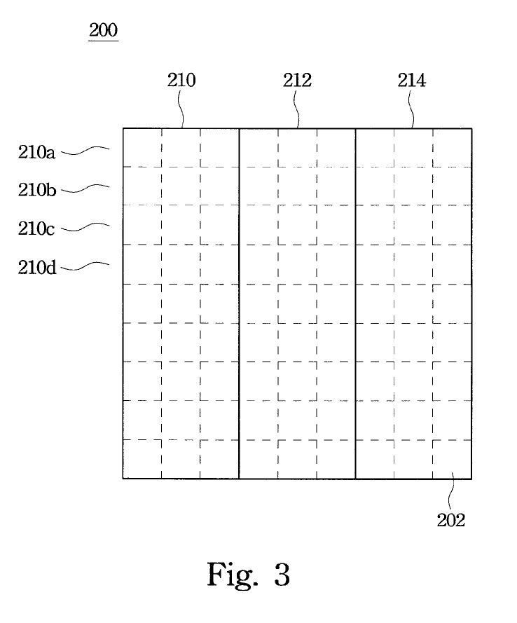

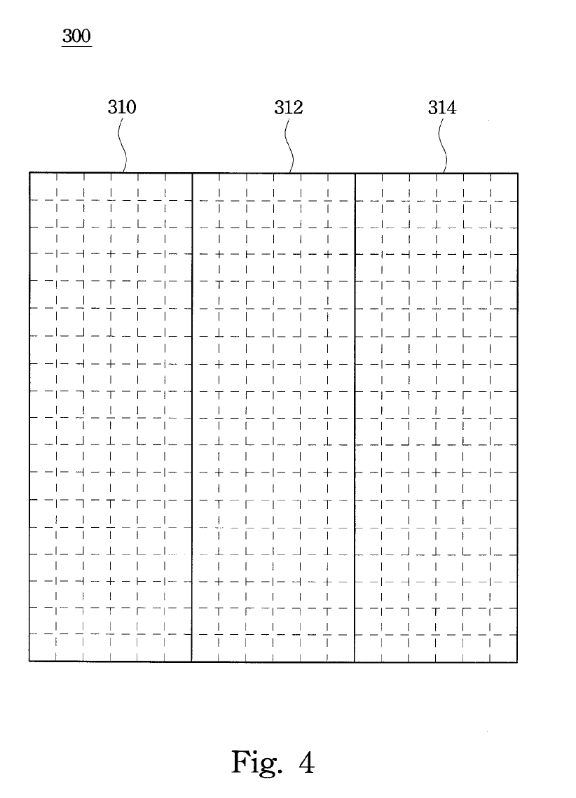

Referring to FIG. 2 through FIG. 4 simultaneously. FIG. 2 is a flow chart showing an image scaling method according to an embodiment of the present invention. FIG. 3 is a structure diagram showing an original image 200 according to the embodiment of the present invention. FIG. 4 is a structure diagram showing a scaled image 300 according to the embodiment of the present invention. In step 100, an original image 200 is provided, wherein the original image 200 comprises a plurality of pixels 202. In step 102, the original image 200 is divided into a plurality of original image columns 210, 212, and 214, wherein the original image column 210 comprises original pixel rows 210a, 210b, 210c, and 210d. In step 104, a scaling step is sequentially performed on the original image columns 210, 212, and 214, thereby generating scaled image columns 310, 312, and 314. In step 106, the scaled image columns 310, 312, and 314 are combined to generate the scaled image 300. In the followings, an example is provided for performing the scaling step on the original image column 210.

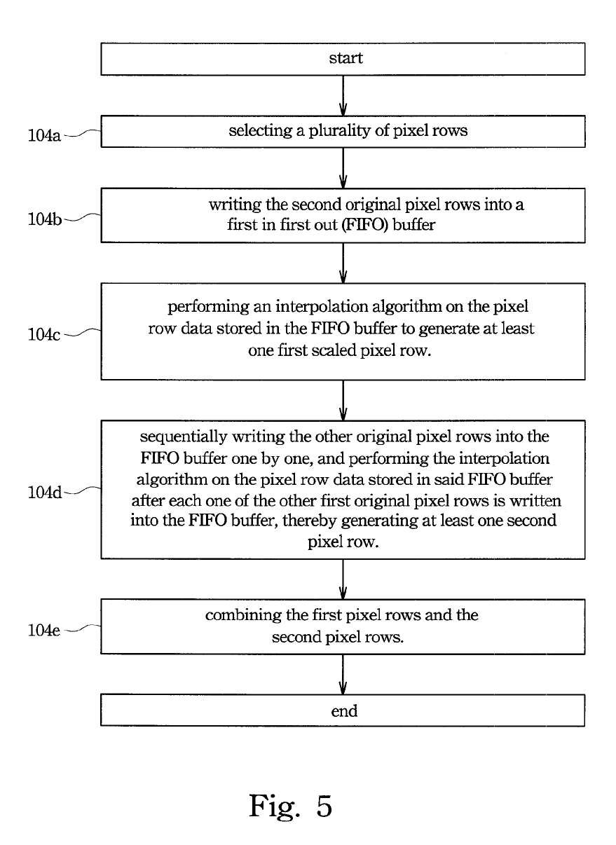

Refer to FIG. 5. FIG. 5 is a flow chart showing the scaling step according to the embodiment of the present invention. In step 104a, the pixel rows 210a and 210b are selected from the pixel rows of the image column 210. The pixel rows selected in step 104a are consecutive to each other, thus that an interpolation algorithm can be performed on them. In step 104b, the pixel rows 210a and 210b are written into a first in first out (FIFO) buffer. The FIFO buffer comprises two memories and the pixel rows 210a and 210b are written into the memories in a one to one manner. In step 104c, an interpolation algorithm is performed on the pixel rows stored in the FIFO buffer, thereby scaling the pixel rows to generate at least one first scaled pixel row of the scaled image column 310. In step 104d, the other original pixel rows (for example: the origin pixel rows 210c and 210d) are sequentially written into the FIFO buffer one by one, and the interpolation algorithm is performed on the pixel row data stored in the FIFO buffer after each one of the other first original pixel rows is written into the FIFO buffer, thereby scaling the pixel row data stored in the line buffer to generate at least one second scaled pixel row of the scaled image column 310. In the embodiment of the present invention, when the origin pixel row 210c is written into the FIFO buffer, the data stored in the FIFO buffer comprises the origin pixel rows 210b and 210c. Then the interpolation algorithm is performed on the origin pixel rows 210b and 210c. Thereafter writing the pixel row 210d into the FIFO buffer. It is noted that because of the FIFO buffer, the pixel rows written into the FIFO buffer are stored sequentially in the memories, but not stored randomly in the memories. In step 104e, the first scaled pixel rows and the second scaled pixel rows are combined to generate the scaled image column 310.

In addition, the number of the pixel rows selected in the step 104a is determined by the interpolation algorithm. In the above embodiment of the present invention, the interpolation algorithm is nearest neighbor interpolation algorithm. In the other embodiment of the present invention, the interpolation algorithm may be linear interpolation, bilinear interpolation, cubic spline interpolation, or cubic convolution algorithm.

In view of the above description, the original image is divided into a plurality columns and the buffer used in the present invention is used to store the pixel rows of one column. Although the buffer stores at least two pixel rows, the size of the line buffer can be decreased by properly choosing the interpolation algorithm and the partition type of the original image.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. An image scaling method, comprising:
providing an original image;
dividing said original image into a plurality of original image columns, wherein each of said original image columns comprises a plurality of first original pixel rows;
respectively performing a scaling step on said original image columns, thereby generating a plurality of scaled image columns, wherein said scaled image columns are one-to-one corresponding to said original image columns, said scaling step comprising:
selecting a plurality of second pixel rows from said first pixel rows with respect to said original image column, wherein said second original pixel rows are consecutive to each other;
writing said second original pixel rows into a first in first out (FIFO) buffer;
performing an interpolation algorithm on the pixel row data stored in said FIFO buffer, thereby scaling the pixel row data to generate at least one first scaled pixel rows;
sequentially writing the other original pixel rows of said first pixel rows into said FIFO buffer one by one, and performing the interpolation algorithm on the pixel row data stored in said FIFO buffer after each one of the other first original pixel rows is written into said FIFO buffer, thereby scaling the pixel row data stored in said line buffers to generate at least one second scaled pixel rows; and
combining said first scaled pixel rows and said second scaled pixel rows to generate said scaled image column; and
combining each of said scaled image columns to generate said scaled image.

2. The image scaling method as claimed in claim 1, wherein said FIFO buffer comprise a plurality of memories, and said second original pixel rows are written into said memories respectively in an one to one manner.

3. The image scaling method as claimed in claim 2, wherein the capacitance of each of said memories is equal to the bits of each of said first original pixel row.

4. The image scaling method as claimed in claim 1, wherein said interpolation algorithm is selected from the group consisting of neighbor interpolation algorithm, linear interpolation algorithm, bilinear interpolation algorithm, cubic spline interpolation algorithm, and cubic convolution interpolation algorithm.
